(19) United States
(12) Patent Application Publication
(10) Pub. No.: US 2014/0372634 A1
(43) Pub. Date: Dec. 18, 2014

(54) INDICATING AND DETECTING CORRECT CABLE CONNECTIONS

(71) Applicant: International Business Machines Corporation, Armonk, NY (US)

(72) Inventors: John K. Langgood, Cary, NC (US); Thomas F. Lewis, Raleigh, NC (US); Kevin M. Reinberg, Chapel Hill, NC (US); Kevin S.D. Vernon, Durham, NC (US); Christopher C. West, Raleigh, NC (US)

(21) Appl. No.: 13/915,662

(22) Filed: Jun. 12, 2013

(51) Int. Cl. G06F 11/30

(52) U.S. Cl. CPC G06F 11/3051
USPC 710/16

(57) ABSTRACT

A method for indicating and detecting correct cable connections within a computer network environment. The method includes determining a topology layout for one or more cables that are connected to one or more system units within a computer network environment. The method includes receiving profile information for the one or more cables and the one or more system units present and determining whether the profile information for the one or more cables and the one or more system units meets requirements for the topology layout. In response to making the determination, the method includes indicating a correct connection between a first cable and a first system unit.

### FIELD OF THE INVENTION

The present invention relates generally to the field of connectors, and more particularly to indicating and detecting correct cable connections.

### BACKGROUND OF THE INVENTION

Corporations today have large data network infrastructures and computer systems, with a typical office building data closet containing numerous interconnected cables to provide increased communication, memory capacity, and operating flexibility. A corporation's cabling system often needs to be adaptable to the needs of the people it serves. Typically, multiple cables of different lengths and capabilities need to attach to specific connection points in an array of components, but with the large number of cables, it may be difficult to determine and install the correct cable to connection point. Other installation problems include space constraints limiting access to, and visibility of, cables and connection points, ability to verify proper connections, and ability to add or remove cables and connection components.

### SUMMARY

Embodiments of the present invention disclose a method, computer program product, and computer system for indicating and detecting correct cable connections within a computer network environment. The method includes determining, by one or more computer processors, a topology layout for one or more cables that are connected to one or more system units within a computer network environment. The method includes receiving, by the one or more computer processors, profile information for the one or more cables and the one or more system units present within the computer network environment. The method then includes determining, by the one or more computer processors, whether the profile information for the one or more cables and the one or more system units meets requirements for the topology layout, and in response to making the determination, indicating, by the one or more computer processors, a correct connection between a first cable and a first system unit.

### BRIEF DESCRIPTION OF THE SEVERAL VIEWS OF THE DRAWINGS

FIG. 1 is a functional block diagram illustrating a computer network environment, in accordance with an embodiment of the present invention.

FIG. 2 is a flowchart depicting operational steps of the connection management module of FIG. 1 for indicating and detecting correct cable connections, in accordance with an embodiment of the present invention.

FIG. 3 depicts a block diagram of components of the user computing device of FIG. 1, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

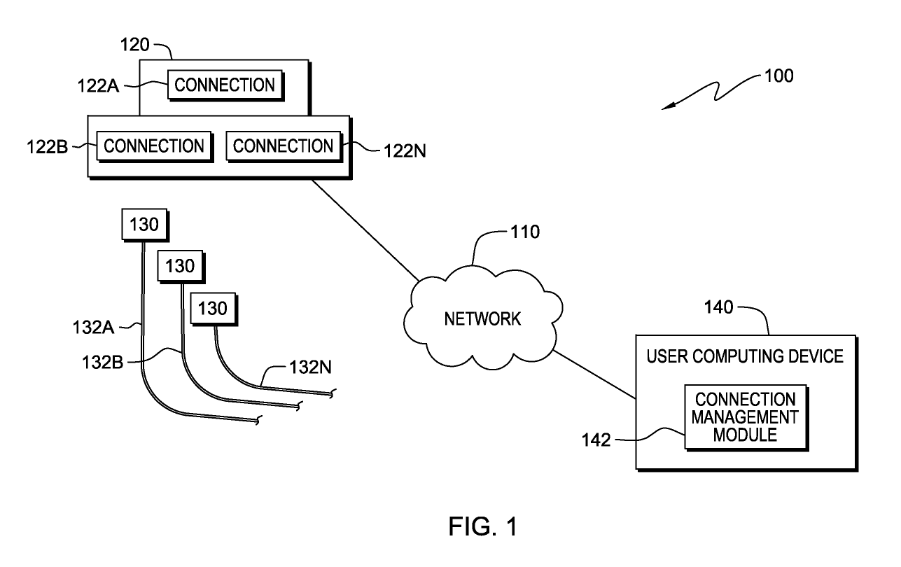

The present invention will now be described in detail with reference to the Figures. FIG. 1 is a functional block diagram illustrating a computer network environment, generally designated 100, for indicating and detecting correct cable connections in accordance with one embodiment of the present invention.

Computer network environment 100 includes system unit 120, microprocessing unit 130, and user computing device 140, all interconnected over network 110. Network 110 can be, for example, a local area network (LAN), a wide area network (WAN) such as the Internet, or a combination of the two, and can include wired, wireless, or fiber optic connections. In general, network 110 can be any combination of connections and protocols that will support communications between system unit 120, microprocessing unit 130, and user computing device 140.

In various embodiments of the present invention, system unit 120 is a rack-mounted system unit including a motherboard, a microprocessor, switches, buses, ports and other processing units and devices necessary to operate and enable a computing device. System unit 120 contains any number of connection points 122A to 122N. Each of connection points 122A to 122N is associated with a visible indicator, such as a colored light, which can be operated by connection management module 142 using microprocessing capabilities of the system unit.

Microprocessing unit 130 is included within, or attached to, each of any number of cables 132A to 132N, and the microproces sing unit is aware of performance capabilities of the cable to which the microprocessing unit is included within, or attached. Performance capabilities of each cable include, for example, speed, length of cable, power capability, and other parameters required, or needed, to make correct connections within computer network environment 100. In various embodiments of the present invention, performance capabilities of each cable can be stored within microprocessing unit 130 during manufacture of the cable and microprocessing unit. In other embodiments, performance capabilities may be loaded into microprocessing unit 130 by a user.

In an exemplary embodiment of the present invention, microproces sing unit 130 is a wireless equipped microprocessor capable of communicating with connection management module 142 via network 110. Additionally, each end of cables 132A to 132N contains a visible indicator, such as a colored light, which can be operated by connection management module 142 using microprocessing unit 130. In various other embodiments of the present invention, a microprocessing unit 130 can be included within, or attached to, each end of each cable 132A to 132N.

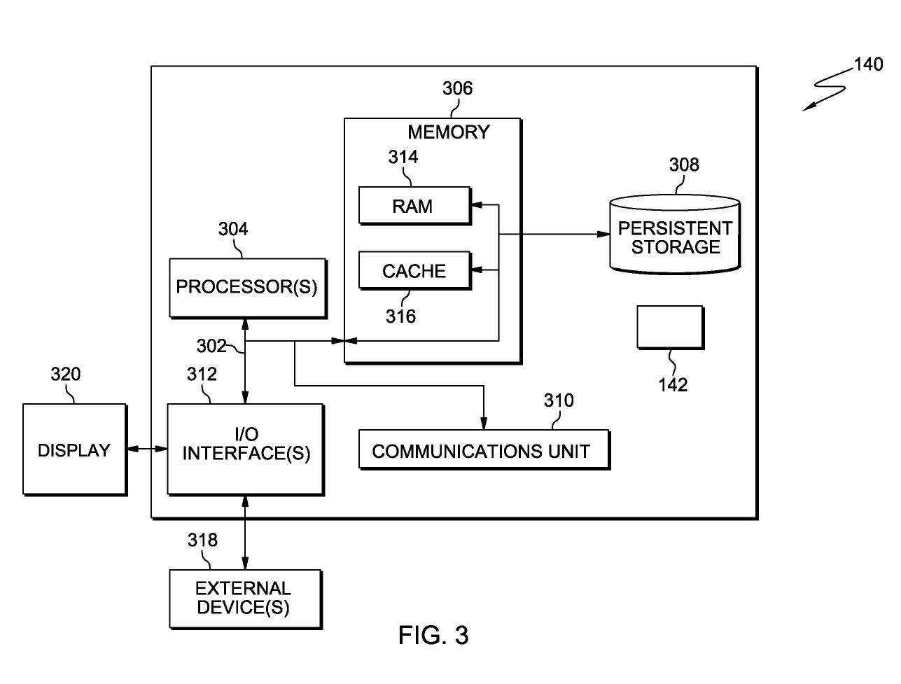

In various embodiments of the present invention, user computing device 140 can be a laptop computer, a tablet computer, a netbook computer, a personal computer (PC), a desktop computer, a personal digital assistant (PDA), a networked server computer, a smart phone, or any programmable electronic device capable of communicating with system unit 120 and microprocessing unit 130 via network 110. User computing device 140 may include internal and external components, as depicted and described in further detail with respect to FIG. 3.

User computing device 140 includes connection management module 142. Connection management module 142 determines a topology layout and inventories cables and system unit connectors, or connection points, within computer network environment 100 to determine system profile information, such as whether the correct cables and connectors are present for the determined topology. In an exemplary embodiment of the present invention, inventory and system profile information, such as parameters of cables and connectors, can be entered into connection management module 142 by a user. In various other embodiments of the present invention, connection management module 142 may have access to a database containing system profile information within computer network environment 100 (not shown).

Connection management module 142 turns on visible indicators on each cable and connector to guide a cable connection installer to make the correct insertion of cable into connector. When a correct connection is made, connection management module 142 turns off the visible indicator and then turns on the visible indicators for the next connection in the topology. When an incorrect connection is made, connection management module indicates an error.

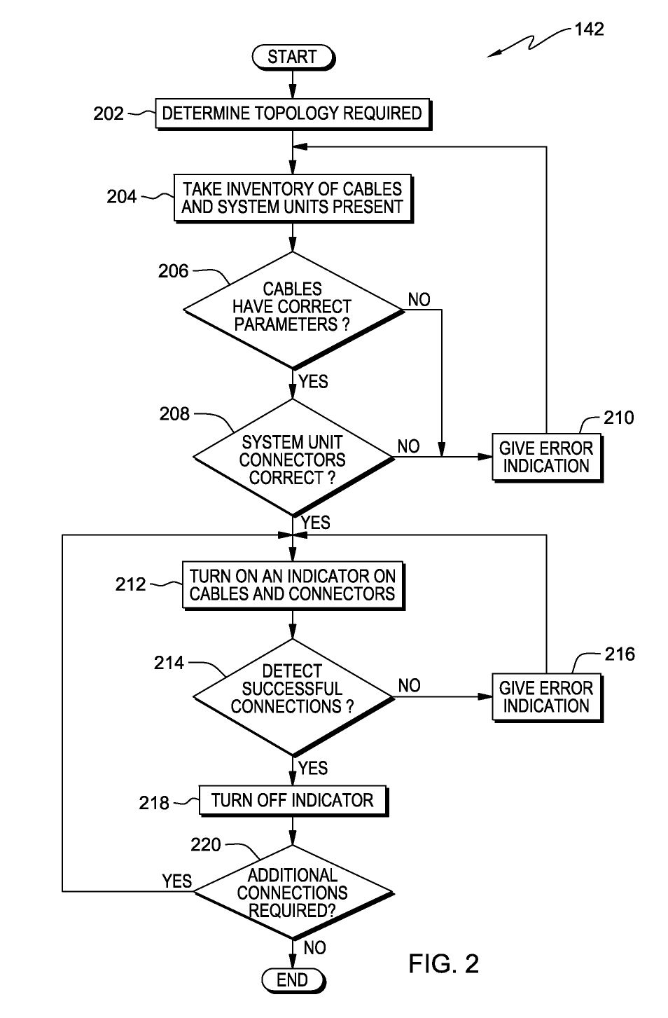

FIG. 2 is a flowchart depicting operational steps of connection management module 142 of FIG. 1 for indicating and detecting correct cable connections, in accordance with an embodiment of the present invention.

Connection management module 142 determines the topology required (step 202). Connection management module 142 determines one of a number of topology layouts, some planned to perform better than others, for a given system, such as system unit 120 in computer network environment 100. Connection management module 142 contains information obtained by, for example, a user entering a system profile, and including the location of each rack, the location of system units within each rack and the location of each target connection within a system unit. In an exemplary embodiment of the present invention, connection management module 142 stores information on the parameters of each cable in the vicinity of the system units obtained from, for example, microprocessing units 130, and profiles for topologies available for the system units and cables.

Topology, specifically physical topology, refers to the placement of various components in the structure of a network, including device location and cable installation. Topology is the layout of cabling, the location of nodes, or connection points, and the interconnections between the nodes and the cabling. The topology of a network is determined by the capabilities of the network access devices and media, the level of control or fault tolerance desired, and the cost associated with cabling or telecommunications circuits. There are several recognized topology layouts, such as point-to-point, mesh, tree, and partial mesh.

Connection management module 142 takes an inventory of cables and system units present within computer network environment 100 (step 204). The inventory includes, for example, parameters of each cable 132A to 132N, such as length or speed, and a number of available connection points 122A to 122N for each system unit. System profile information, such as parameters and capabilities of the cables and connections points within computer network environment 100, can be entered by a user into connection management module 142. Additionally, parameters and capabilities of each cable 132 may be obtained via network 110 from communications with respective microprocessing units 130.

Connection management module 142 determines whether the cables present have the correct parameters for the determined topology (decision block 206). If the cables present do not have the correct parameters (decision block 206, “no” branch), connection management module 142 gives an error indication (step 210). In various embodiments of the present invention, the error indication may be displayed to a user and include a summary of what cables are required or needed, a suggestion to move or relocate rack and/or system unit to match the available cables, or a suggestion for a new or alternate topology to match the available cables. Connection management module 142 returns to take inventory of the cables and system units present within the computer network environment.

If the cables present do have the correct parameters for the determined topology (decision block 206, “yes” branch), connection management module 142 determines whether the system unit connectors present are correct for the determined topology (decision block 208). If the system unit connectors present are not correct (decision block 208, “no” branch), connection management module 142 gives the error indication, as discussed above (step 210).

If the system unit connectors present are correct for the determined topology (decision block 208, “yes” branch), connection management module 142 turns on an indicator on the cables and connectors for a first connection (step 212). In an exemplary embodiment of the present invention, each end of matching target cables and system unit target connectors will be illuminated with a visible indicator, such as a “green” light emitting diode (“LED”). When the determined topology permits several correct connection options or target connectors, multiple visible indicators may be turned on, for example, different color LEDs or different variations of blinking visible indicators. Visible indicators may include colored LED lights, white LED lights, other lights or illuminating agents, either solid or blinking, dial gauges, switches, buttons, or any other means which can be used to point out, show, display, or designate one cable or connection point instead of another.

Connection management module 142 detects whether connections made are successful (decision block 214). If connections made are not successful (decision block 214, “no” branch), connection management module 142 gives an error indication (step 216). In an exemplary embodiment of the present invention, the error indication may include an alternate color LED, such as “red”, when an incorrect connection is made. In various other embodiments, the error indication may be an error message displayed to a user. As the incorrect connection is removed, connection management module 142 removes, or turns off, the error LED and re-indicates, or illuminates, the correct target connection points.

If the connections made are successful (decision block 214, “yes” branch), connection management module 142 turns off the indicator (step 218). In an exemplary embodiment of the present invention, both the system unit connector and cable visible indicators are turned off.

Connection management module 142 determines whether additional connections are required for the determined topology (decision block 220). If additional connections are required (decision block 220, “yes” branch), connection management module 142 turns on an indicator on the cable and the connector for the next connection point (step 212). If there are no additional connections required for the determined topology (decision block 220, “no” branch), connection management module 142 ends.

In an alternate embodiment, connection management module 142 may turn on an indicator at the system unit connection point, and not on the cable. When a cable is connected, connection management module 142 determines if the connection is correct. If it is correct, the indicator at the correct connection is turned off. If the connection is not correct, connection management module 142 may either give an error indication at both ends of the inappropriate cable, or give an error indication at one end, but indicate a correct connection at the other end of the cable and at a system unit connection point.

FIG. 3 depicts a block diagram of components of user computing device 140 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

User computing device 140 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Connection management module 142 is stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including system unit 120 and microprocessing unit 130. In these examples, communications unit 310 includes one or more network interface cards. Communications unit 310 may provide communications through the use of either or both physical and wireless communications links. Connection management module 142 may be downloaded to persistent storage 308 through communications unit 310.

I/O interface(s) 312 allows for input and output of data with other devices that may be connected to user computing device 140. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., connection management module 140, can be stored on such portable computer-readable storage media and can be loaded onto persistent storage 308 via I/O interface(s) 312. I/O interface(s) 312 also connect to a display 320. Display 320 provides a mechanism to display data to a user and may be, for example, a computer monitor or an incorporated display screen, such as is used in tablet computers and smart phones.

The programs and modules described herein are identified based upon the application for which they are implemented in a specific embodiment of the invention. However, it should be appreciated that any particular program or module nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for indicating and detecting correct cable connections within a computer network environment, the method comprising:
determining, by one or more computer processors, a topology layout for one or more cables that are connected to one or more system units within a computer network environment;
receiving, by the one or more computer processors, profile information for the one or more cables and the one or more system units present within the computer network environment;
determining, by the one or more computer processors, whether the profile information for the one or more cables and the one or more system units meets requirements for the topology layout; and
in response to determining that the profile information for the one or more cables and the one or more system units meets requirements for the topology layout, indicating, by the one or more computer processors, a first correct connection between a first cable and a first system unit, wherein indicating the first correct connection between the first cable and the first system unit includes at least illuminating a visible indicator on at least one end of the first cable prior to making the first correct connection.

2. The method of claim 1, further comprising:
determining, by the one or more computer processors, for a second cable, a next correct connection; and
indicating, by the one or more computer processors, the next correct connection.

3. The method of claim 1, further comprising:
determining, by the one or more computer processors, whether the indicated correct connection between the first cable and the first system unit was made; and
in response to determining the indicated correct connection was made, removing, by the one or more computer processors, the indication of the correct connection.

4. The method of claim 3, further comprising, in response to determining the indicated correct connection between the first cable and the first system unit was not made, displaying an error indication, the error indication including one or more of an error message, a list of required cables, a new topology, and a relocation of system units.

5. The method of claim 1, wherein indicating a correct connection between a first cable and a first system unit further comprises:
illuminating a visible indicator on the first system unit, wherein the visible indicator includes one or more of: colored LED lights, white LED lights, blinking LED lights, or a dial gauge.

6. The method of claim 1, wherein receiving profile information for the one or more cables and the one or more system units further comprises:
determining, by the one or more computer processors, parameters for each of the one or more cables, the parameters including one or more of: length, speed, and power capability; and
determining, by the one or more computer processors, connectors present on each of the one or more system units.

7. The method of claim 1, wherein the determined topology layout includes at least one of a required layout of the one or more cables, a location of the one or more system units, a location of connectors present on the one or more system units, and a layout of interconnections between the one or more cables and the one or more system units.

8. A computer program product for indicating and detecting correct cable connections within a computer network environment, the computer program product comprising:
one or more computer-readable tangible storage media and program instructions stored on the one or more computer-readable tangible storage media, wherein the one or more computer-readable tangible storage media is hardware, the program instructions comprising:
program instructions to determine a topology layout for one or more cables that are connected to one or more system units within a computer network environment;
program instructions to receive profile information for the one or more cables and the one or more system units present within the computer network environment;
program instructions to determine whether the profile information for the one or more cables and the one or more system units meets requirements for the topology layout; and
in response to determining that the profile information for the one or more cables and the one or more system units meets requirements for the topology layout, program instructions to indicate a first correct connection between a first cable and a first system unit, wherein the program instructions to indicate the first correct connection between the first cable and the first system unit include at least program instructions to illuminate a visible indicator on at least one end of the first cable prior to making the first correct connection.

9. The computer program product of claim 8, further comprising:
program instructions to determine, for a second cable, a next correct connection; and
program instruction to indicate the next correct connection.

10. The computer program product of claim 8, further comprising:
program instructions to determine whether the indicated correct connection between the first cable and the first system unit was made; and
in response to determining the indicated correct connection was made, program instructions to remove the indication of the correct connection.

11. The computer program product of claim 10, further comprising, in response to determining the indicated correct connection between the first cable and the first system unit was not made, program instructions to display an error indication, the error indication including one or more of an error message, a list of required cables, a new topology, and a relocation of system units.

12. The computer program product of claim 8, wherein program instructions to indicate a correct connection between a first cable and a first system unit further comprise:
program instructions to illuminate a visible indicator on the first system unit, wherein the visible indicator includes one or more of: colored LED lights, white LED lights, blinking LED lights, or a dial gauge.

13. The computer program product of claim 8, wherein program instructions to receive profile information for the one or more cables and the one or more system units further comprise:
program instructions to determine parameters for each of the one or more cables, the parameters including one or more of: length, speed, and power capability; and
program instructions to determine connectors present on each of the one or more system units.

14. The computer program product of claim 8, wherein the determined topology layout includes at least one of a required layout of the one or more cables, a location of the one or more system units, a location of connectors present on the one or more system units, and a layout of interconnections between the one or more cables and the one or more system units.

15. A computer system for indicating and detecting correct cable connections, the computer system comprising:
one or more computer processors;
one or more computer-readable tangible storage media;
program instructions stored on the one or more computer-readable tangible storage media for execution by at least one of the one or more computer processors, wherein the one or more computer-readable tangible storage media is hardware, the program instructions comprising:
program instructions to determine a topology layout for one or more cables that are connected to one or more system units within a computer network environment;
program instructions to receive profile information for the one or more cables and the one or more system units present within the computer network environment;
program instructions to determine whether the profile information for the one or more cables and the one or more system units meets requirements for the topology layout; and
in response to determining that the profile information for the one or more cables and the one or more system units meets requirements for the topology layout, program instructions to indicate a correct connection between a first cable and a first system unit, wherein the program instructions to indicate the first correct connection between the first cable and the first system unit include at least program instructions to illuminate a visible indicator on at least one end of the first cable prior to making the first correct connection.

16. The computer system of claim 15, further comprising:
program instructions to determine, for a second cable, a next correct connection; and
program instruction to indicate the next correct connection.

17. The computer system of claim 15, further comprising:
program instructions to determine whether the indicated correct connection between the first cable and the first system unit was made; and
in response to determining the indicated correct connection was made, program instructions to remove the indication of the correct connection.

18. The computer system of claim 17, further comprising, in response to determining the indicated correct connection between the first cable and the first system unit was not made, program instructions to display an error indication, the error indication including one or more of an error message, a list of required cables, a new topology, and a relocation of system units.

19. The computer system of claim 15, wherein program instructions to indicate a correct connection between a first cable and a first system unit further comprise:
program instructions to illuminate a visible indicator on the first system unit, wherein the visible indicator includes one or more of: colored LED lights, white LED lights, blinking LED lights, or a dial gauge.

20. The computer system of claim 15, wherein program instructions to receive profile information for the one or more cables and the one or more system units further comprise:
program instructions to determine parameters for each of the one or more cables, the parameters including one or more of: length, speed, and power capability; and
program instructions to determine connectors present on each of the one or more system units.
